(19) United States
(12) Patent Application Publication
(10) Pub. No.: US 2022/0411586 A1
(43) Pub. Date: Dec. 29, 2022

(54) Composition for Forming Polyimide Film, Method for Preparing the Same, and Use Thereof

(71) Applicants: SK Innovation Co., Ltd., Seoul (KR); SK ie technology Co., Ltd., Seoul (KR)

(72) Inventors: Cheol Min Yun, Daejeon (KR); Hye Jin Park, Daejeon (KR)

(21) Appl. No.: 17/838,904

(22) Filed: Jun. 13, 2022

(30) Foreign Application Priority Data
Jun. 14, 2021 (KR) 10-2021-0076667

(51) Int. Cl. C08G 73/10

(52) U.S. Cl. CPC C08G 73/1082

(57) ABSTRACT

Provided are a composition for forming a polyimide film, a method for preparing the same, and a use thereof. According to an implementation, a polyimide film which has excellent heat resistance, is flexible, and has excellent bending properties, without deteriorating colorless and transparent optical properties may be provided. In addition, the polyimide film according to an implementation may be useful for various flexible display devices.

### CROSS-REFERENCE TO RELATED APPLICATION

This application claims priority to Korean Patent Application No. 10-2021-0076667 filed Jun. 14, 2021, the disclosure of which is hereby incorporated by reference in its entirety.

### BACKGROUND OF THE INVENTION

### Field of the Invention

The following disclosure relates to a composition for forming a polyimide film, a method for preparing the same, and a use thereof.

### Description of Related Art

In recent years, it has been important to make a display device lighter, slimmer, and more flexible. A glass substrate which has been widely used in a conventional display is heavy, brittle, inflexible, and difficult to be subjected to a continuous process, and thus, a study for applying a polymer substrate for replacing the glass substrate, which is light, flexible, and subjected to continuous process, to a flexible display is being actively conducted. Among them, polyimide (PI) which is a polymer being easily synthesized and having excellent heat resistance, chemical resistance, and the like is mainly used.

A substrate material for a next-generation display device should have excellent optical properties, and also, be accompanied by improvement of flexibility and mechanical properties for being applied to a foldable or flexible display device. Furthermore, a flexible device involves a high temperature process, and, in particular, since a process temperature of an organic light emitting diode (OLED) device using a low temperature polysilicon (LIPS) process is 350° C. or higher or approaches 500° C., excellent heat resistance is required.

Meanwhile, the color of common polyimide is brown or yellow, and the main cause thereof is a charge transfer complex (CTC) by intramolecular and intermolecular interactions of polyimide. This lowers a light transmittance and increases birefringence of a polyimide film to affect viewing sensibility of a display device.

In order to solve the problem, monomers having various structures are combined or changed to decrease a CTC effect, thereby preparing colorless and transparent polyimide. However, optical properties and heat resistance are in a trade-off relationship with each other, and the attempt is bound to produce extremely general results of decreased functionality or deteriorated heat resistance, in spite of better optical properties of polyimide. Thus, studies for improving color transparency and optical properties are continued within a range which does not significantly reduce heat resistance and mechanical properties of polyimide, but there is a limit to satisfying all of them.

Therefore, development of a flexible display substrate material which may satisfy implementation of improved optical properties and excellent heat resistance without deteriorating colorless and transparent properties to replace tempered glass is needed.

### SUMMARY OF THE INVENTION

An embodiment is directed to providing a composition for forming a polyimide film which may satisfy required performance of an advanced display substrate material, and a polyimide film manufactured therefrom.

Specifically, an embodiment is directed to providing a polyimide film which may implement both excellent optical properties and excellent heat resistance, and a multilayer structure including the same.

Another embodiment is directed to providing a method for preparing a composition for forming a polyimide film for implementing the physical properties described above, and a method for manufacturing a polyimide film.

Still another embodiment is directed to providing a polyimide film which may replace tempered glass and the like and a flexible display device including the same, and provides a new display substrate material satisfying both excellent optical properties and heat resistance.

### [Solution to Problem]

In one general aspect, a composition for forming a polyimide film includes: a polyamic acid or polyimide including a structural unit derived from a dianhydride and a structural unit derived from a diamine; and a mixed solvent of an amide-based solvent and a hydrocarbon-based solvent, wherein the composition satisfies the following Relation 1, the structural unit derived from a dianhydride includes a structural unit derived from one or two or more selected from compounds represented by the following Chemical Formulae 1 to 3, and the structural unit derived from a diamine includes a structural unit derived from a compound represented by the following Chemical Formula 4:

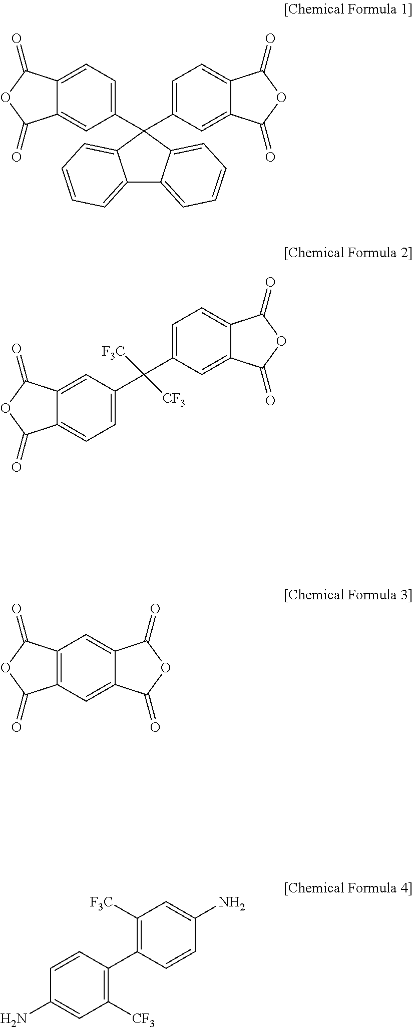

3,000≤V_{PI}≤10,000 [Relation 1]

wherein

V_{PI} is a viscosity of the composition for forming a polyimide film when a solid content is 19 wt % with respect to a total weight of the composition for forming a polyimide film, and the viscosity is a viscosity (unit, cp) measured based on 80% torque for 2 minutes using a 52Z spindle at 25° C. with a Brookfield rotational viscometer.

The structural unit derived from a dianhydride may include the structural unit derived from the compound represented by the following Chemical Formula 3, and the structural unit derived from a diamine may include the structural unit derived from the compound represented by the following Chemical Formula 4:

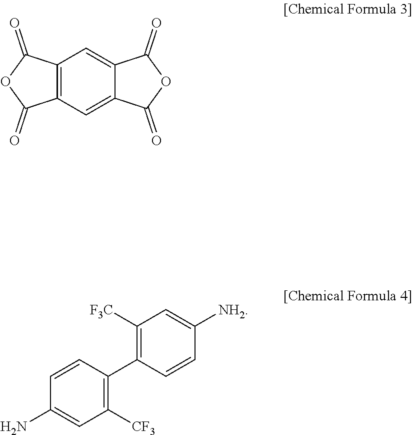

The structural unit derived from a dianhydride may further include the structural unit derived from the compound represented by the following Chemical Formula 1, the structural unit derived from the compound represented by Chemical Formula 2, or a combination thereof:

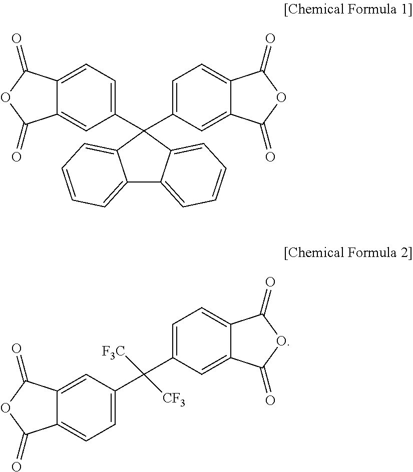

The amide-based solvent may include dimethylpropionamide.

The hydrocarbon-based solvent may be a cyclic hydrocarbon-based solvent.

The cyclic hydrocarbon-based solvent may be toluene, benzene, cyclohexane, or a combination thereof.

The composition for forming a polyimide film may have a solid content of 10 to 40 wt % with respect to a total weight of the composition for forming a polyimide film.

The composition for forming a polyimide film may include the amide-based solvent and the hydrocarbon-based solvent at a weight ratio of 8:2 to 5:5.

In another general aspect, a method for preparing a composition for forming a polyimide film includes: i) reacting one or two or more dianhydrides selected from compounds represented by the following Chemical Formulae 1 to 3 and a diamine represented by the following Chemical Formula 4 in the presence of an amide-based solvent to prepare a polyamic acid solution; and ii) further adding a hydrocarbon-based solvent so that the following Relation 1 is satisfied, to adjust a viscosity:

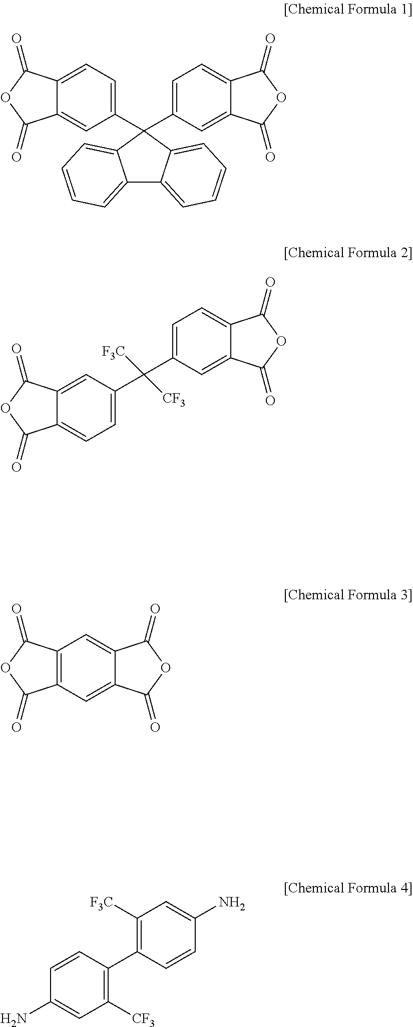 [SMILES: O=C1OC(=O)c2cc(C3(c4ccc5c(c4)C(=O)OC5=O)c4ccccc4-c4ccccc43)ccc21 ; O=C1OC(=O)c2cc(C(c3ccc4c(c3)C(=O)OC4=O)(C(F)(F)F)C(F)(F)F)ccc21 ; O=c1oc(=O)c2cc3c(=O)oc(=O)c3cc12 ; Nc1ccc(-c2ccc(N)cc2C(F)(F)F)c(C(F)(F)F)c1]

[Relation 1]

3,000≤V_{PI}≤10,000, wherein V_{PI} is as previously defined for Relation 1.

Step ii) may include: further adding 5 to 50 parts by weight of a hydrocarbon-based solvent with respect to 100 parts by weight of the amide-based solvent of step i) and performing stirring; and further adding a mixed solvent of the amide-based solvent and the hydrocarbon-based solvent so that Relation 1 is satisfied.

In another general aspect, a polyimide film manufactured from the composition for forming a polyimide film may be provided.

The polyimide film may have a coefficient of thermal expansion (CTE) of 15 ppm/° C. or less as measured in a temperature range of 100 to 450° C. by a thermomechanical analysis (TMA) method.

The polyimide film may have a thickness of 4 to 12 um and a yellow index (YI) in accordance with ASTM E313 of 15 or less.

In another general aspect, a method for manufacturing a polyimide film includes: an application step of applying the composition for forming a polyimide film on a substrate; and a curing step of drying and heating the composition for forming a polyimide film to performing curing.

The curing step may be performed by drying at 30° C. to 80° C. and then heating at 100° C. to 450° C., and after the application step, a step of allowing the applied substrate to stand at room temperature may be further included.

In still another general aspect, a multilayer structure includes the polyimide film and a semiconductor layer on one surface of a substrate.

The semiconductor layer may include one or two or more selected from the group consisting of low-temperature polysilicon (LTPS), low-temperature polycrystalline oxide (LTPO), indium tin oxide (ITO), and indium gallium zinc oxide (IGZO).

### Advantageous Effects of Invention

The composition for forming a polyimide film according to an implementation may inhibit an interaction of a polyamic acid and a mixed solvent to significantly decrease an intermolecular packing density during curing. Thus, a polyimide film which may implement both excellent optical properties and excellent heat resistance without deteriorating colorless and transparent properties may be provided.

In addition, the composition for forming a polyimide film according to an implementation uses a mixed solvent of an amide-based solvent and a hydrocarbon-based solvent, thereby significantly lowering the viscosity of the composition even with a high solid content included. Thus, the composition for forming a polyimide film according to an implementation may be applied to a thin film coating process with a high solid content and a low viscosity, and desired physical properties may be effectively implemented.

Specifically, the composition for forming a polyimide film according to an implementation may provide a polyimide film which implements a significantly improved yellow index and also has a low coefficient of thermal expansion. Thus, the present invention may be applied to a substrate material of a display device for LTPS and/or LTPO required for a high-temperature process.

In addition, the polyimide film according to an implementation also has flexibility, and thus, may be useful for a substrate material of a flexible display. When the polyimide film according to an implementation is adopted as a substrate material of a flexible display, viewing sensibility of a display device may be improved, and the reliability and thermal stability of a display device may be increased.

### DESCRIPTION OF THE INVENTION

Hereinafter, an implementation will be described in detail so as to be easily practiced by a person skilled in the art to which the present invention pertains. However, the present invention may be implemented in various different forms and is not limited to the implementations described herein. In addition, it is not intended to limit the protection scope defined in the claims.

In addition, technical terms and scientific terms used in the present specification have the general meaning understood by a person skilled in the art unless otherwise defined, and description for the known function and configuration obscuring the present invention will be omitted in the following description.

Throughout the present specification, unless explicitly described to the contrary, “comprising” any constituent elements will be understood to imply further inclusion of other constituent elements rather than the exclusion of any other constituent elements.

Hereinafter, unless otherwise defined in the present specification, it will be understood that when a part such as a layer, a film, a thin film, a region, or a plate is referred to as being “on” or “above” another part, it may include not only the case of being “directly on” the other part but also the case of intervening another part therebetween.

Hereinafter, unless otherwise defined in the present specification, a “combination thereof” refers to a mixture or copolymerization of constituents.

Hereinafter, unless otherwise particularly defined in the present specification, the term “A and/or B” may refer to an embodiment including both A and B or an embodiment selecting one of A and B.

Hereinafter, unless otherwise particularly defined in the present specification, a “polymer” refers to a molecule which has a relatively high molecular weight and the structure may include multiple repetition of a unit derived from a low molecular weight molecule. In an embodiment, the polymer may be an alternating copolymer, a block copolymer, a random copolymer, a branched copolymer, a crosslinked copolymer, or a copolymer including all of them (for example, a copolymer including more than one monomer). In another embodiment, the polymer may be a homopolymer (for example, a copolymer including one monomer).

Hereinafter, unless otherwise particularly defined in the present specification, a “polyamic acid” refers to a polymer including a structural unit having an amic acid moiety, and a “polyimide” may refer to a polymer including a structural unit having an imide moiety.

Hereinafter, unless otherwise particularly defined in the present specification, a polyimide film may be a film including a polyimide, specifically, a high heat-resistant film produced by subjecting a dianhydride compound and a diamine compound or a diisocyanate compound to solution polymerization to prepare a polyamic acid, which is then cyclized and dehydrated at a high temperature to be imidized.

Hereinafter, the composition for forming a polyimide film according to an implementation will be described.

The composition for polyimide film formation according to an implementation (hereinafter, also referred to as a polyimide film-forming composition) may have both improved optical properties and improved heat resistance, by changing solvent conditions, specifically, applying a non-polar solvent which may not be used as a polymerization solvent of a polyamic acid (hereinafter, also referred to as a polyimide precursor) and/or polyimide and has no compatibility with polyimide.

Specifically, the composition for forming a polyimide film according to an implementation may include a polyamic acid and/or polyimide; a polar solvent; and a non-polar solvent. The polar solvent may be a hydrophilic solvent, for example, may have compatibility with a polyamic acid and/or polyimide, and for example, may be an amide-based solvent. In addition, the non-polar solvent may have little compatibility with a polyamic acid and/or polyimide, and for example, may be a hydrocarbon-based solvent.

Without being bound to a specific theory, by using a mixed solvent of an amide-based solvent and a hydrocarbon-based solvent, an intermolecular interaction between polymers and/or an interaction between a polymer and a solvent may be effectively inhibited, and intermolecular packing density during curing may be significantly decreased, so that both excellent optical properties and excellent heat resistance may be imparted. In addition, by using the mixed solvent, the viscosity of the composition is lowered, and a composition for forming a polyimide film having a high solid content may be prepared. Thus, the composition for forming a polyimide film according to an implementation may be applied to a thin film coating process with a high solid content and a low viscosity, and may provide an advantage of being excellent in implementing desired physical properties.

The composition for forming a polyimide film according to an implementation may represent intermolecular behavior and interaction which are different from those in the case of simply adding a mixed solution in a step of polymerizing a polyamic acid. For example, when in the step of polymerizing a polyamic acid, the hydrocarbon-based solvent is included, it acts as a factor inhibiting polymerization, so that a high molecular weight polyamic acid may not be obtained. However, in the composition for forming a polyimide film according to an implementation, the hydrocarbon-based solvent is mixed after obtaining a sufficient amount of high molecular weight polyamic acid and/or polyimide, and thus, the solvent may act as a catalyst which weakens an intermolecular interaction between polymers and/or a strong interaction between a polymer and a solvent, and may impart excellent optical properties in later curing.

Composition for Forming a Polyimide Film

The composition for forming a polyimide film according to an implementation includes: a polyamic acid or polyimide including a structural unit derived from a dianhydride and a structural unit derived from a diamine; and a mixed solvent of an amide-based solvent and a hydrocarbon-based solvent, wherein the structural unit derived from a dianhydride includes a structural unit derived from one or two or more selected from compounds represented by the following Chemical Formulae 1 to 3, and the structural unit derived from a diamine includes a structural unit derived from a compound represented by the following Chemical Formula 4.

In addition, the composition for forming a polyimide film according to an implementation may satisfy the following Relation 1. Without being bound to a specific theory, the composition for forming a polyimide film satisfying the conditions as such may be advantageous for application to a thin film process at the time of film formation, inhibit a packing density of a polyimide film during curing, and make the film amorphous, thereby improving optical properties.

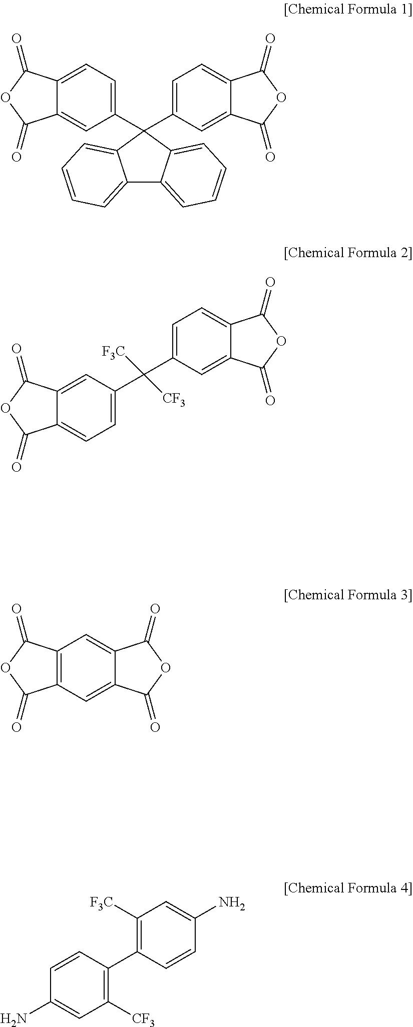 [SMILES: O=C1OC(=O)c2cc(C3(c4ccc5c(c4)C(=O)OC5=O)c4ccccc4-c4ccccc43)ccc21 ; O=C1OC(=O)c2cc(C(c3ccc4c(c3)C(=O)OC4=O)(C(F)(F)F)C(F)(F)F)ccc21 ; O=c1oc(=O)c2cc3c(=O)oc(=O)c3cc12 ; Nc1ccc(-c2ccc(N)cc2C(F)(F)F)c(C(F)(F)F)c1]

3,000≤V_{PI}≤10,000 [Relation 1]

wherein

V_{PI} is a viscosity of the composition for forming a polyimide film when a solid content is 19 wt % with respect to a total weight of the composition for forming a polyimide film, and the viscosity is a viscosity (unit, cp) measured based on 80% torque for 2 minutes using a 52Z spindle at 25° C. with a Brookfield rotational viscometer.

In an implementation, the structural unit derived from a dianhydride may include the structural unit derived from the compound represented by Chemical Formula 3, and the structural unit derived from a diamine may include the structural unit derived from the compound represented by Chemical Formula 4. Here, the structural unit derived from a dianhydride may further include the structural unit derived from the compound represented by Chemical Formula 1, the structural unit derived from the compound represented by Chemical Formula 2, or a combination thereof.

The composition for forming a polyimide film according to an implementation may include the amide-based solvent and the hydrocarbon-based solvent at a weight ratio of 8:2 to 5:5, specifically at a weight ratio of 7.5:2.5 to 5:5, and more specifically at a weight ratio of 7.5:2.5 to 5.5:4.5. Since the solvent mixed at the weight ratio described above is included, reactivity between the diamine and the dianhydride may be maintained excellent, and intermolecular packing density may be appropriately inhibited and the composition may be made amorphous during curing of the composition for forming a polyimide film. Accordingly, a polyimide film having a further improved yellow index may be provided without deteriorating heat resistance and mechanical properties.

A viscosity (V_{PI}) of the composition for forming a polyimide film according to an implementation may satisfy 10,000 cp or less, 8,0000 cp or less, 3,000 to 8,000 cp, or 3,000 to 7,000 cp.

Accordingly, the composition for forming a polyimide film including a high solid content may be applied to a thin film process more easily, and a polyimide film having better colorless and transparent properties, optical properties, and heat resistance may be provided. The solid content may be the polyamic acid and/or polyimide.

Specifically, a cured film formed by curing the composition for forming a polyimide film, that is, a polyimide film, may be flexible, colorless, and transparent, and implement excellent heat resistance. Accordingly, the polyimide film according to an implementation may be applied to a substrate material of a display device for LIPS and/or LTPO required for a high-temperature process, and also has excellent flexibility, and thus, may be useful for a substrate material of a flexible display and the like. That is, by adopting the polyimide film according to an implementation as a substrate material of a flexible display, the viewing sensibility of a display device may be further improved and the reliability and the thermal stability of a display device may be increased.

More specifically, the composition for forming a polyimide film according to an implementation may be a mixture of a polyamic acid solution including a polyamic acid including structural units derived from one or two or more dianhydrides selected from the compounds represented by Chemical Formulae 1 to 3 and the diamine represented by Chemical Formula 4 and an amide-based solvent with the hydrocarbon-based solvent and a mixed solvent so that Relation 1 is satisfied.

Here, by using the amide-based solvent and the hydrocarbon-based solvent sequentially, an interaction between the polyamic acid which is a polyimide precursor and the solvent may be adjusted to a more appropriate range. Here, the adjustment may refer to inhibition.

Diamine and Dianhydride

The composition for forming a polyimide film according to an implementation includes a structural unit derived from a diamine represented by Chemical Formula 4, thereby providing a film having more improved optical properties.

In addition, the diamine may be used in combination with one or two or more selected from p-phenylenediamine (PDA), m-PDA (m-phenylenediamine), 4,4′-oxydianiline (4,4′-ODA), 3,4′-oxydianiline (3,4′-ODA), 2,2-bis(4-[4-aminophenoxy]-phenyl)propane (BAPP), 1,4-bis(4-aminophenoxy)benzene (TPE-Q), 1,3-bis(4-aminophenoxy)benzene (TPE-R), 4,4′-bis(4-aminophenoxy)biphenyl (BAPB), 2,2-bis(4-[4-aminophenoxy]phenyl)sulfone (BAPS), 2,2-bis(4-[3-aminophenoxy]phenyl)sulfone (m-BAPS), 3,3′-dihydroxy-4,4′-diaminobiphenyl (HAB), 3,3′-dimethylbenzidine (TB), 2,2′-dimethylbenzidine (m-TB), 2,2′-bistrifluoromethylbenzidine (TFMB), 1,4-bis(4-amino-2-trifluoromethylphenoxy)benzene (6FAPB), 2,2′-bis(trifluoromethyl)-4,4′-diaminodiphenylether (6FODA), 1,3-bis(3-aminophenoxy)benzene (APB), 1,4-naphthalenediamine (1,4-ND), 1,5-naphthalenediamine (1,5-ND), 4,4′-diaminobenzanilide (DABA), 6-amino-2-(4-aminophenyl)benzoxazole, 5-amino-2-(4-aminophenyl)benzoxazole, and the like, if necessary, but is not limited thereto.

The composition for forming a polyimide film according to an implementation may include the structural unit derived from one or two or more dianhydrides selected from Chemical Formulae 1 to 3, thereby providing a film having more improved mechanical strength and heat resistance. In addition, an interaction between the polyamic acid prepared therefrom and the solvent is effectively inhibited to significantly lower an intermolecular packing density during curing, thereby providing an advantage of excellence in desired optical properties.

In addition, the dianhydride may further include pyromellitic dianhydride (PMDA), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 4,4′-(4,4′-isopropylbiphenoxy)biphthalic anhydride (BPADA), 3,3′,4,4′-diphenylsulfonetetracarboxylic dianhydride (DSDA), 2,2-bis-(3,4-dicarboxylphenyl) hexafluoropropane dianhydride (6FDA), p-phenylenebistrimellitic monoester anhydride (TMHQ), 2,2′-bis(4-hydroxyphenyl)propanedibenzoate-3,3′,4,4′-tetracarboxylic dianhydride (ESDA), naphthalenetetracarboxylic dianhydride (NTDA), or a combination thereof.

Solvent

The composition for forming a polyimide film according to an implementation uses a mixed solvent of an amide-based solvent and a hydrocarbon-based solvent, thereby effectively inhibiting an intermolecular interaction between polymers and/or an interaction between a polymer and a solvent, and significantly decreasing an intermolecular packing density during curing, so that both optical properties and heat resistance may be improved. Furthermore, by using the mixed solvent, the composition for forming a polyimide film may have a low viscosity while having a high solid content. Thus, the composition for forming a polyimide film according to an implementation has a low viscosity while including a high solid content, thereby forming a thin film more easily by a solution process. In addition, a polyimide film having an excellent yellow index without deteriorating mechanical properties and heat resistance may be provided.

In the composition for forming a polyimide film according to an implementation, the amide-based solvent refers to a compound having an amide moiety. The amide-based solvent may be a cyclic compound or a chain compound, and specifically, a chain compound. The chain compound may have 2 to 15 carbon atoms, and more specifically, 3 to 10 carbon atoms.

The amide-based solvent may include a N,N-dialkylamide moiety, and the dialkyl groups may be present independently or be fused with each other to form a ring, or at least one alkyl group of the dialkyl groups is fused with other substituents in the molecule to form a ring, and for example, at least one alkyl group of the dialkyl groups may be fused with an alkyl group connected to carbonyl carbon of an amide moiety to form a ring. Here, the ring may be 4-membered to 7-membered rings, for example, 5-membered to 7-membered rings, and for example, a 5-membered or 6-membered ring. The alkyl group may be a C1 to C10 alkyl group, for example, a C1 to C8 alkyl group, and for example, methyl, ethyl, and the like.

More specifically, the amide-based solvent is not limited as long as it is generally used in polymerization of the polyamic acid, but for example, may include dimethylpropionamide, diethylpropionamide, dimethylacetylamide, diethylacetamide, dimethylformamide, methylpyrrolidone, ethylpyrrolidone, octylpyrrolidone, or a combination thereof, and specifically, may include dimethylpropionamide.

In the composition for forming a polyimide film according to an implementation, the hydrocarbon-based solvent may be a non-polar molecular as described above.

The hydrocarbon-based solvent may be a compound formed of carbon and hydrogen. For example, the hydrocarbon-based solvent may be aromatic or aliphatic, and for example, a cyclic compound or a chain compound, but specifically, may be a cyclic compound. Here, when the hydrocarbon-based solvent is a cyclic compound, it may include a monocycle or a polycycle, and the polycycle may be a condensed ring or a non-condensed ring, but specifically a monocycle may be used.

The hydrocarbon-based solvent may have 3 to 15 carbon atoms, for example, 6 to 15 carbon atoms, and for example, 6 to 12 carbon atoms.

The hydrocarbon-based solvent may be a substituted or unsubstituted C3 to C15 cycloalkane, a substituted or unsubstituted C6 to C15 aromatic compound, or a combination thereof. Here, the cycloalkane may be cyclobutane, cyclopentane, cyclohexane, cycloheptane, cyclooctane, or a combination thereof, and the aromatic compound may include benzene, naphthalene, or a combination thereof.

The hydrocarbon-based solvent may be cycloalkane which is unsubstituted or substituted with at least one C1 to C5 alkyl group, an aromatic compound which is unsubstituted or substituted with at least one C1 to C5 alkyl group, or a combination thereof, and each of the cycloalkane and the aromatic compound may be as described above.

The C1 to C5 alkyl group may be, for example, a C1 to C3 alkyl group, for example, a C1 or C2 alkyl group, and more specifically, a methyl group, but is not limited thereto.

In addition, the hydrocarbon-based solvent may further include oxygen, if necessary. For example, when the hydrocarbon-based solvent includes oxygen, it may include a ketone group or a hydroxyl group, and for example, may be cyclopentanone, cresol, or a combination thereof.

Specifically, the hydrocarbon-based solvent may be benzene, toluene, cyclohexane, cyclopentanone, cresol, or a combination thereof, but is not limited thereto.

More specifically, the composition for forming a polyimide film according to an implementation may include a mixed solvent including an amide-based solvent including dimethylpropionamide and a hydrocarbon-based solvent selected from toluene, benzene, cyclohexane, and the like.

The hydrocarbon-based solvent according to an implementation may be added after polymerization of a polyamic acid or polyimide.

Accordingly, the composition for forming a polyimide film according to an implementation may represent intermolecular behavior and interaction which are different from those in the case of simply adding a mixed solution in a step of polymerizing a polyamic acid. For example, when in the step of polymerizing a polyamic acid, the hydrocarbon-based solvent is included, it acts as a factor inhibiting polymerization, so that a high molecular weight polyamic acid may not be obtained. However, in the composition for forming a polyimide film according to an implementation, the hydrocarbon-based solvent is mixed after obtaining a sufficient amount of high molecular weight polyamic acid and/or polyimide, and thus, the solvent may act as a catalyst which weakens an intermolecular interaction between polymers and/or a strong interaction between a polymer and a solvent, and may obtain desired optical properties in later curing.

The composition for forming a polyimide film according to an implementation may include the amide-based solvent and the hydrocarbon-based solvent at a weight ratio of 8:2 to 5:5, specifically at a weight ratio of 7.5:2.5 to 5:5, and more specifically at a weight ratio of 7.5:2.5 to 5.5:4.5. Accordingly, better optical properties are implemented, and also excellent reactivity of diamine and dianhydride may be maintained.

Polyamic Acid and Polyimide

The composition for forming a polyimide film according to an implementation includes a polyamic acid and polyimide including the structural units derived from the diamine and the dianhydride exemplified above.

A weight average molecular weight (Mw) of the polyamic acid and/or polyamide is not particularly limited, but may be 10,000 g/mol or more, specifically, 20,000 g/mol or more, and more specifically 25,000 to 80,000 g/mol. The polyamic acid and the polyimide have the weight average molecular weight in the range described above, thereby providing a film having better optical properties and mechanical strength, and less curl.

A solid content of the composition for forming a polyimide film according to an implementation may satisfy a range of 40 wt % or less, 35 wt % or less, 30 wt % or less, or 15 to 25 wt %, based on the total weight of the composition for forming a polyimide film. Here, the solid content may be the polyamic acid and/or the polyimide.

Usually, polyimide has a higher viscosity with a higher solid content, and for example, when the polyamic acid and/or the polyimide is dissolved in a common amide-based solvent alone, the viscosity of the solution is as high as 15,000 cp or more or 10,000 cp or more. Here, the viscosity of the solution refers to a viscosity when a solid content is 19 wt % with respect to the total weight of the solution. In the case in which a thin film is manufactured by a solution process, for example, a coating process, when a polymer flow is not good due to a high viscosity, it is difficult to remove bubbles and mura occurs during coating.

However, the composition for forming a polyimide film according to an implementation uses a mixed solvent of an amide-based solvent and a hydrocarbon-based solvent, thereby significantly lowering the viscosity of the composition even when a high solid content of 19 wt % or more is included. Accordingly, defects occurring in a solution process, for example, a coating process may be effectively prevented, thereby implementing more improved optical properties. Besides, a solid content is high without defects occurring in the coating process, which may be commercially advantageous.

Method for Preparing Composition for Forming a Polyimide Film

According to an implementation, a method for preparing a composition for forming a polyimide film including: i) reacting one or two or more dianhydrides selected from compounds represented by Chemical Formulae 1 to 3 and a diamine represented by Chemical Formula 4 in the presence of an amide-based solvent to prepare a polyamic acid solution; and ii) further adding a hydrocarbon-based solvent so that Relation 1 is satisfied, to adjust a viscosity, is provided.

Specifically, in step i), the diamine and the dianhydride are mixed at a mole ratio of 1:0.9 to 1:1.1 to be polymerized into a polyamic acid, and the step may include dissolving a diamine in the present of an amide-based solvent at a temperature of 20 to 30° C.; adding and dissolving a dianhydride while maintaining the temperature of the solution; and stirring the reaction solution for 5 hours to 7 hours to perform a reaction.

The reaction solution of step i) according to an implementation may include a solid content of 15 to 40 wt %, and more preferably 20 to 35 wt %, based on the total weight of the reaction solution. Within the numerical value range, the polymerization reaction of the diamine and the dianhydride may be maintained excellent, and a polyamic acid having a desired weight average molecular weight may be obtained.

In step ii) according to an implementation, the hydrocarbon solvent described above is further added, stirring is performed, and a mixed solvent of the amide-based solvent and the hydrocarbon-based solvent is further added, so that the viscosity range of the composition for forming a polyimide film satisfies Relation 1.

Specifically, step ii) includes further adding 5 to 50, or 5 to 25 parts by weight of the hydrocarbon-based solvent with respect to 100 parts by weight of the amide-based solvent of step i) at room temperature (25° C.) and performing stirring for 15 hours to 20 hours; and after completing the stirring, adding a mixed solvent of the amide-based solvent and the hydrocarbon-based solvent so that Relation 1 is satisfied. Without being bound to a specific theory, the composition for forming a polyimide film satisfying the conditions inhibits the packing density of the polyimide film during curing and may be made amorphous. Accordingly, a polyimide film for a cover window having a further improved yellow index without deteriorating mechanical properties and heat resistance may be provided.

In addition, the composition for forming a polyimide film according to an implementation may represent intermolecular behavior and interaction which are different from those in the case of simply adding a mixed solution in a step of polymerizing a polyamic acid. For example, when in the step of polymerizing a polyamic acid, the hydrocarbon-based solvent is included, it acts as a factor inhibiting polymerization, so that a high molecular weight polyamic acid may not be obtained.

However, in the composition for forming a polyimide film according to an implementation, the polyamic acid and/or polyimide having a sufficiently high molecular weight is/are obtained, and then the hydrocarbon-based solvent is mixed therewith, thereby obtaining a polyamic acid having a high molecular weight. In addition, the hydrocarbon-based solvent may act as a catalyst which weakens an interaction between polymers and/or a strong interaction between a polymer and a solvent, and in later curing, desired optical properties may be obtained.

Molded Body

The molded body according to an implementation may be a molded body manufactured by using the composition for forming a polyimide film.

A first embodiment of the molded body according to an implementation may be a polyimide film.

In addition, a second embodiment of the molded body according to an implementation may be a multilayer structure including the polyimide film.

In addition, a third embodiment of the molded body according to an implementation may be a flexible display device including the polyimide film.

The polyimide film according to an implementation may have a thickness satisfying 4 to 12 um, for example, 5 to 11 um, or for example, 6 to 10 um.

The polyimide film according to an implementation may have a yellow index (YI) in accordance with ASTM E131 satisfying 15 or less, 12 or less, 10 or less, or 8 or less.

The polyimide film according to an implementation may satisfy excellent optical properties such as a transmittance and also further decrease distortion caused by light.

The polyimide film according to an implementation may have a coefficient of thermal expansion (CTE) of 15 ppm/° C. or less, 13 ppm/° C. or less, 10 ppm/° C. or less, or 9 ppm/° C. or less, as measured in a temperature range of 100 to 450° C. by a thermomechanical analysis (TMA) method. By having the coefficient of thermal expansion in the range described above, the polyimide film according to an implementation has better heat resistance, and thus, when used as a substrate of a display device, may suppress substrate warpage and the like more effectively.

In addition, the multilayer structure according to an implementation may include the polyimide film according to an implementation and a semiconductor layer, formed on a substrate. A non-limiting example of the semiconductor layer may include low-temperature polysilicon (LTPS), low-temperature polycrystalline oxide (LTPO), indium tin oxide (ITO), indium gallium zinc oxide (IGZO), and the like, and for example, may include LIPS and/or LTPO.

A display device using low-temperature polysilicon (LIPS) and/or low-temperature polycrystalline oxide (LTPO) may have a process temperature of 350° C. or higher, or approaching 500° C. In the high-temperature process as such, even polyimide having excellent heat resistance easily undergoes thermal decomposition by hydrolysis. Therefore, for manufacturing a flexible device for LIPS and/or LTPO, a material having excellent heat resistance which does not undergo thermal decomposition by hydrolysis even in a high-temperature process is demanded. The polyimide film according to an implementation has both excellent optical properties and excellent heat resistance, thereby being used in a display device for LIPS and/or LTPO.

In addition, a specific example of the molded body manufactured using the composition for forming a polyimide film may include a flexible display panel or a flexible display device including the multilayer structure, but is not limited thereto. Here, the polyimide film may be used as a lower substrate of the flexible display device, and the flexible display device may be various image display devices such as a common liquid crystal display device, an electroluminescent display device, a plasma display device, and a field emission display device.

Method for Manufacturing Polyimide Film

In addition, the method for manufacturing a polyimide film may include: i) an application step of applying the composition for forming a polyimide film on a substrate; and ii) a curing step of drying and heating the composition for forming a polyimide film to performing curing.

Specifically, in step i), the composition for forming a polyimide film is applied on a substrate such as glass, and the application method is not limited as long as it is commonly used in the art. A non-limiting example thereof may include knife coating, dip coating, roll coating, slot die coating, lip die coating, slide coating, curtain coating, and the like, and the same or different kind of application may be successively applied once or more thereto, of course.

In addition, the substrate may be used without limitation as long as it is commonly used in the art, and a non-limiting example thereof may include glass; stainless steel; or plastic films such as polyethylene terephthalate, polyethylene naphthalate, polypropylene, polyethylene, cellulose triacetate, cellulose diacetate, poly(meth)acrylic acid alkyl ester, poly(meth)acrylic acid ester copolymer, polyvinyl chloride, polyvinyl alcohol, polycarbonate, polystyrene, cellophane, polyvinylidene chloride copolymer, polyamide, polyimide, vinyl chloride/vinyl acetate copolymer, polytetrafluoroethylene, and polytrifluoroethylene, and the like, but the present invention is not limited thereto.

In step ii) according to an implementation, the drying is for removing the solvent present in the composition for forming a polyimide film, and may be performed at 30 to 80° C., 40 to 80° C., or 50 to 80° C.

The thermal curing according to an implementation may be performed at 100 to 450° C., 120 to 450° C., or 150 to 450° C.

More specifically, the thermal curing may be performed at 80 to 100° C. for 1 minute to 2 hours, at higher than 100° C. to 200° C. for 1 minute to 2 hours, or at higher than 200° C. to 450° C. for 1 minute to 2 hours, and stepwise thermal curing may be performed under two or more temperature conditions selected therefrom. In addition, the thermal curing may be performed in a separate vacuum oven, an oven filled with inert gas, or the like, but the present invention is not necessarily limited thereto.

The curing step may be performed by chemical curing.

The chemical curing may be performed using an imidization catalyst, and a non-limiting example of the imidization catalyst may include any one or two or more selected from pyridine, isoquinoline, β-quinoline, and the like, but is not necessarily limited thereto.

The method for manufacturing a polyimide film may further include a standing step of applying the composition for forming a polyimide film on the substrate, and then allowing it to stand at room temperature, if necessary.

The optical properties on the film surface may be more stably maintained by the standing step. Without being bound to a certain theory, when a conventional composition for forming a polyimide film is subjected to the standing step as such before curing, the solvent absorbs moisture in the air, and the moisture diffuses inside and collides with the polyamic acid and/or polyimide to cause cloudiness from the film surface and to cause agglomeration, thereby causing coating unevenness. However, the composition for forming a polyimide film according to an implementation has no cloudiness and agglomeration even when allowed to stand in the air for a long time, and may secure a film having improved optical properties.

The standing step may be performed at room temperature and/or in a high humidity condition. Here, the room temperature may be 40° C. or lower, for example, 30° C. or lower, for example, 25° C. or lower, more specifically, 15° C. to 25° C., and particularly preferably, 20 to 25° C. In addition, high humidity may be a relative humidity of 50% or more, for example, 60% or more, for example, 70% or more, and for example, 80% or more.

The standing step may be performed for 1 minute to 3 hours, for example, 10 minutes to 2 hours, and for example, 20 minutes to 1 hour.

In the method for manufacturing a polyimide film according to an implementation, the polyimide film may be mixed with one or two or more additives selected from a flame retardant, an adhesive strength improver, inorganic particles, an anti-oxidant, a UV blocking agent, a plasticizer, and the like to manufacture the polyimide film.

Hereinafter, an example will be described for describing an implementation in detail, but the present invention is not limited to the following examples.

In the following experimentation, the physical properties were measured as follows.

<Viscosity (V_{PI})>

0.5 ul of a composition for forming a polyimide film (solid content of 19 wt %) was put in a container with a cone plate rheometer (Brookfield, LVDV-1II Ultra), a spindle was lowered and rpm was adjusted, and after being left for 2 minutes when reaching a torque of 80%, a viscosity value when there was no torque change was measured. At this time, the viscosity was measured using a 52Z spindle under the temperature condition of 25° C. The unit was cp.

<Yellow Index (YI)>

A yellow index was measured using a spectrophotometer (from Nippon Denshoku, COH-5500) in accordance with the standard of ASTM D313.

<Weight Average Molecular Weight>

A weight average molecular weight was measured by dissolving a film in a DMAc eluent containing 0.05 M LiCl. GPC was performed using Waters GPC system, Waters 1515 isocratic HPLC Pump, and Waters 2414 Refractive Index detector, by connecting Olexis, Polypore and a mixed D column as a column, using polymethylmethacrylate (PMMA STD) as a standard material, and analysis was performed at 35° C. at a flow rate of 1 mL/min.

<Coefficient of Thermal Expansion>

A coefficient of thermal expansion was measured with TMA (TA, Q400). A film having a size of 5×20 mm was prepared, and the sample was loaded using an accessory. An actual measured lengths of a film were all made equal to 16 mm. A film pulling force was set to 0.02 N, a first temperature raising temperature was performed at a temperature rise rate of 5° C./min, and a cooling process was performed in a temperature range of 450 to 100° C. at a cooling rate of 4° C./min, thereby measuring the coefficient of thermal expansion.

### Example 1

Preparation of Composition for Forming Polyimide Film (TFMB (0.985)/PMDA (1))

An agitator in which a nitrogen stream flowed was filled with 146 g of N,N-dimethylpropionamide (DMPA), and 28.98 g of 2,2-bistrifluoromethylbenzidine (TFMB) was dissolved therein in a state in which the temperature of the reactor was maintained at 25° C. 20 g of pyromellitic dianhydride (PMDA) was added thereto at room temperature (25°) and dissolved therein with stirring. After stirring for 6 hours, 62.6 g of toluene was added thereto at 25° C., and stirring was performed for 18 hours. Thereafter, a mixed solvent of DMPA:toluene=70 wt %:30 wt % was added so that the solid content was 19 wt % based on the total weight of the composition, thereby preparing a composition for forming a polyimide film 1.

<Manufacture of Polyimide-Based Film>

The composition for forming a polyimide film obtained above was applied on one surface of a glass substrate (1.0 T) with a #20 meyer bar, heating was performed at 80° C. for 30 minutes and then at 450° C. for 40 minutes under a nitrogen stream to perform curing, and then a film was peeled off from the glass substrate, thereby obtaining a polyimide film of Example 1 having a thickness of 7 μm.

### Examples 2 and 3

Preparation of Composition for Forming Polyimide Film

Compositions for forming a polyimide film 2 and 3 having a solid content of 19 wt % and including a mixed solvent of DMPA:toluene=70 wt %:30 wt % were prepared in the same manner as in Example 1, except that the kind and the mole ratio of the monomers (diamine and dianhydride) shown in Table 1 were used.

<Manufacture of Polyimide Film>

Polyimide films of Examples 2 and 3 having a thickness of 7 μm were obtained in the same manner as in Example 1, using the obtained composition for forming a polyimide film.

### Example 4

Preparation of Composition for Forming Polyimide Film

A composition for forming a polyimide film 4 having a solid content of 19 wt % and including a mixed solvent of DEAc:toluene=70 wt %:30 wt % was prepared in the same manner as in Example 1, except that the kind and the mole ratio of the monomers (diamine and dianhydride) shown in Table 1 were used, and diethylacetamide (DEAc) was used instead of DMPA.

<Manufacture of Polyimide Film>

A polyimide film of Examples 4 having a thickness of 7 μm was obtained in the same manner as in Example 1, using the obtained composition for forming a polyimide film.

### Examples 5 and 6

Preparation of Composition for Forming Polyimide Film

Compositions for forming a polyimide film 5 and 6 were prepared in the same manner as in Example 3, except that DMPA and/or toluene were added so that the content of toluene satisfied the T content in Table 1 with respect to the total weight of DMPA and toluene.

<Manufacture of Polyimide Film>

Polyimide films of Examples 5 and 6 having a thickness of 7 μm were obtained in the same manner as in Example 1, using the obtained composition for forming a polyimide film.

### Comparative Example 1

Preparation of Composition for Forming Polyimide Film (TFMB (0.985)/PMDA (1))

An agitator in which a nitrogen stream flowed was filled with 220.8 g of DMPA, and 28.9 g of TFMB was dissolved in a state in which the temperature of the reactor was maintained at 25° C. 20 g of PMDA was added thereto at room temperature and dissolved therein with stirring. After stirring for 24 hours, DMPA was added thereto so that the solid content was 19 wt % with respect to the total weight of the composition, thereby preparing composition for forming a polyimide film A.

<Manufacture of Polyimide Film>

A polyimide film of Comparative Examples 1 having a thickness of 7 μm was obtained in the same manner as in Example 1, using the obtained composition for forming a polyimide film.

### Comparative Examples 2 and 3

Preparation of composition for forming polyimide film Compositions for forming a polyimide film B and C having a solid content of 19 wt % were prepared in the same manner as in Comparative Example 1, except that the kind and the mole ratio of the monomers (diamine and dianhydride) shown in Table 1 were used.

<Manufacture of Polyimide Film>

Polyimide films of Comparative Examples 2 and 3 having a thickness of 7 μm were obtained in the same manner as in Example 1, using the obtained composition for forming a polyimide film.

### Comparative Example 4

Preparation of Composition for Forming Polyimide Film

A composition for forming a polyimide film D having a solid content of 19 wt % was prepared in the same manner as in Comparative Example 1, except that the kind and the mole ratio of the monomers (diamine and dianhydride) shown in Table 1 were used and DEAc was used instead of DMPA.

<Manufacture of Polyimide Film>

A polyimide film of Comparative Examples 4 having a thickness of 7 μm was obtained in the same manner as in Example 1, using the obtained composition for forming a polyimide film.

### Comparative Examples 5 and 6

Preparation of Composition for Forming Polyimide Film

Compositions for forming a polyimide film F and G were prepared in the same manner as in Example 3, except that DMPA and/or toluene were added so that the content of toluene satisfied the T content in Table 1 with respect to the total weight of DMPA and toluene.

<Manufacture of Polyimide Film>

Polyimide films of Comparative Examples 5 and 6 having a thickness of 7 μm were obtained in the same manner as in Example 1, using the obtained composition for forming a polyimide film.

TABLE 1

| | | Example | Example | Example | Example | Example | Example |
|---|---|---|---|---|---|---|---|
| | | 1 | 2 | 3 | 4 | 5 | 6 |
| Diamine | TFMB | 0.985 | 0.985 | 0.985 | 0.985 | 0.985 | 0.985 |
| Dian- | BPAF | | 0.3 | | 0.25 | | |
| hydride | 6FDA | | | 0.3 | | 0.3 | 0.3 |
| | PMDA | 1 | 0.7 | 0.7 | 0.75 | 0.7 | 0.7 |
| T content | | 30 | 30 | 30 | 30 | 25 | 45 |
| (wt %) | | | | | | | |
| | | Com- | Com- | Com- | Com- | Com- | Com- |
| | | parative | parative | parative | parative | parative | parative |
| | | Example | Example | Example | Example | Example | Example |
| | | 1 | 2 | 3 | 4 | 5 | 6 |
| Diamine | TFMB | 0.985 | 0.985 | 0.985 | 0.985 | 0.985 | 0.985 |
| Dian- | BPAF | | 0.3 | | 0.25 | | |
| hydride | 6FDA | | | 0.3 | | 0.3 | 0.3 |
| | PMDA | 1 | 0.7 | 0.7 | 0.75 | 0.7 | 0.7 |

| | | | | | | |
|---|---|---|---|---|---|---|
| T content | 0 | 0 | 0 | 0 | 10 | 60 |
| (wt %) | | | | | | |

<Evaluation of Optical Properties of Polyimide Film>

The physical properties of the polyimide films manufactured in Examples 1 to 6 and Comparative Examples 1 to 6 were measured and are shown in the following Table 2. The viscosity in the following Table 2 is the viscosity of the composition for forming a polyimide film prepared in Examples 1 to 6 and Comparative Examples 1 to 6.

TABLE 2

| | Example 1 | Example 2 | Example 3 | Example 4 | Example 5 | Example 6 |
|---|---|---|---|---|---|---|
| T content | 30 | 30 | 30 | 30 | 25 | 45 |
| (wt %) | | | | | | |
| Viscosity | 7800 | 5900 | 5300 | 7000 | 5600 | 4500 |
| (cp) | | | | | | |
| Thickness | 7 | 7 | 7 | 7 | 7 | 7 |
| (μm) | | | | | | |
| YI | 11.2 | 5.6 | 5.5 | 6.1 | 6.2 | 5.8 |
| CTE | −20.5 | 7.8 | 8.3 | 6.5 | 7.9 | 8.5 |
| (100~ | | | | | | |
| 450° C.) | | | | | | |
| | Com- | Com- | Com- | Com- | Com- | Com- |
| | parative | parative | parative | parative | parative | parative |
| | Example 1 | Example 2 | Example 3 | Example 4 | Example 5 | Example 6 |
| T content | 0 | 0 | 0 | 0 | 10 | 60 |
| (wt %) | | | | | | |
| Viscosity | 16000 | 8000 | 8600 | 8400 | 12000 | un- |
| (cp) | | | | | | measurable |
| Thickness | 7 | 7 | 7 | 7 | 7 (surface | Unable to |
| (μm) | | | | | unevenness) | manufacture |
| YI | 16.5 | 9.2 | 8.5 | 9.5 | 8.2 | film |

Referring to Table 2, it is confirmed that the compositions for forming a polyimide film according to Examples 1 to 6 included the mixed solvent of the amide-based solvent and the hydrocarbon-based solvent, thereby having a viscosity of 3,000 to 10,000 cp even with a high solid content included. Accordingly, it is confirmed that the compositions for forming a polyimide film according to Examples 1 to 6 may form a film having a sufficient thickness to be used as a substrate of a flexible display and having excellent heat resistance and optical properties. In addition, the films manufactured from the compositions for forming a polyimide film according to Examples 1 to 6 were flexible and had excellent bending properties, and thus, may be useful as a flexible display substrate.

However, it is confirmed that the compositions for forming a polyimide film manufactured from Comparative Examples 1 to 4 had an increased intermolecular packing density during thermal curing, and thus, the optical properties and the heat resistant properties of the polyimide film manufactured therefrom were all not good.

In addition, the composition for forming a polyimide film according to Comparative Example 5 had a high viscosity as compared with the solid content and had not-removed bubbles, thereby having a difficulty in manufacture of a polyimide film, and produced an uneven coating surface. Thus, since the surface of a coating layer was somewhat rough after curing, it was evaluated as being poor, and was confirmed to be unsuitable for being applied to polyimide film formation. Furthermore, the composition for forming a polyimide film of Comparative Example 5 had a rough surface after being coated, and was confirmed to have significantly deteriorated optical properties.

In addition, the composition for forming a polyimide film according to Comparative Example 6 had a high initial polymerization solid content, so that a solution viscosity was uncontrollably high, and thus, polymerization and manufacture of the polyimide film were impossible.

Hereinabove, an implementation has been described by specific examples, this has been provided only for assisting in the entire understanding of the present invention, and the present invention is not limited to the examples. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

What is claimed is:

1. A composition for forming a polyimide film comprising:
a polyamic acid or polyimide comprising a structural unit derived from a dianhydride and a structural unit derived from a diamine; and
a mixed solvent of an amide-based solvent and a hydrocarbon-based solvent,
wherein the composition satisfies the following Relation 1,
the structural unit derived from a dianhydride comprises a structural unit derived from one or two or more selected from compounds represented by the following Chemical Formulae 1 to 3, and the structural unit derived from a diamine comprises a structural unit derived from a compound represented by the following Chemical Formula 4: 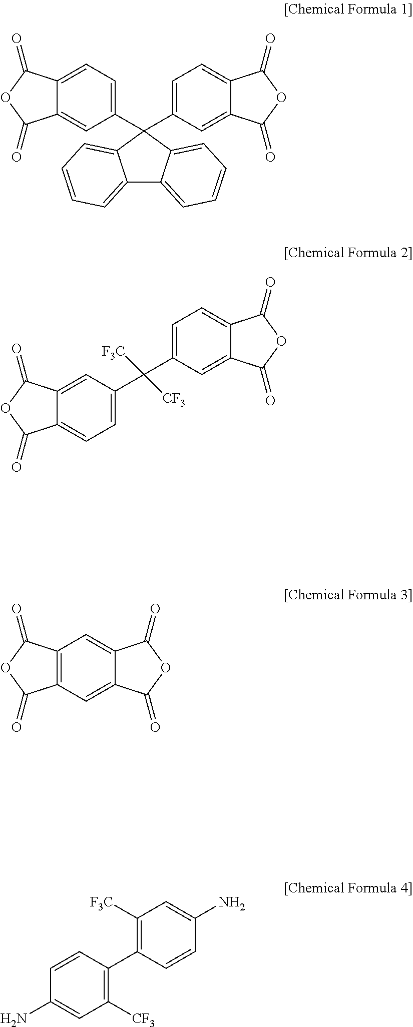
3,000≤V_{PI}≤10,000 [Relation 1]
wherein
V_{PI} is a viscosity of the composition for forming a polyimide film when a solid content is 19 wt % with respect to a total weight of the composition for forming a polyimide film, and the viscosity is a viscosity (unit, cp) measured based on 80% torque for 2 minutes using a 52Z spindle at 25° C. with a Brookfield rotational viscometer.

2. The composition for forming a polyimide film of claim 1, wherein
the structural unit derived from a dianhydride comprises the structural unit derived from the compound represented by the following Chemical Formula 3, and the structural unit derived from a diamine comprises the structural unit derived from the compound represented by the following Chemical Formula 4:

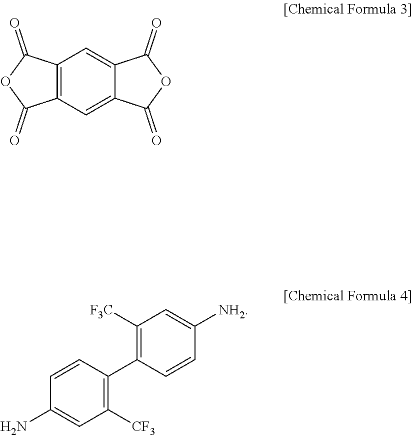

3. The composition for forming a polyimide film of claim 2, wherein
the structural unit derived from a dianhydride further comprises the structural unit derived from the compound represented by the following Chemical Formula 1, the structural unit derived from the compound represented by Chemical Formula 2, or a combination thereof:

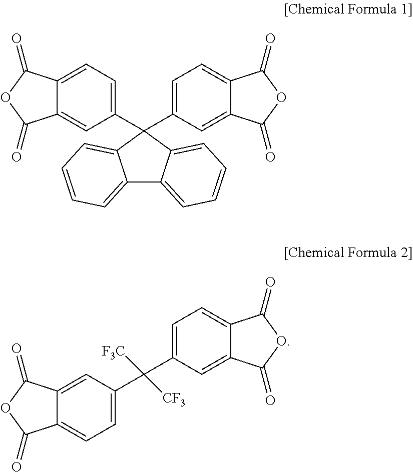

4. The composition for forming a polyimide film of claim 1, wherein the amide-based solvent comprises dimethylpropionamide.

5. The composition for forming a polyimide film of claim 1, wherein the hydrocarbon-based solvent is a cyclic hydrocarbon-based solvent.

6. The composition for forming a polyimide film of claim 5, wherein the cyclic hydrocarbon-based solvent comprises toluene, benzene, cyclohexane, or a combination thereof.

7. The composition for forming a polyimide film of claim 1, wherein the composition for forming a polyimide film has a solid content of
10 to 40 wt % with respect to a total weight of the composition for forming a polyimide film.

8. The composition for forming a polyimide film of claim 1, wherein the composition for forming a polyimide film comprises the amide-based solvent and the hydrocarbon-based solvent at a weight ratio of 8:2 to 5:5.

9. A method for preparing a composition for forming a polyimide film, the method comprising the steps of:
i) reacting one or two or more dianhydrides selected from compounds represented by the following Chemical Formulae 1 to 3 and a diamine represented by the following Chemical Formula 4 in the presence of an amide-based solvent to prepare a polyamic acid solution; and
ii) further adding a hydrocarbon-based solvent so that the following Relation 1 is satisfied, to adjust a viscosity: 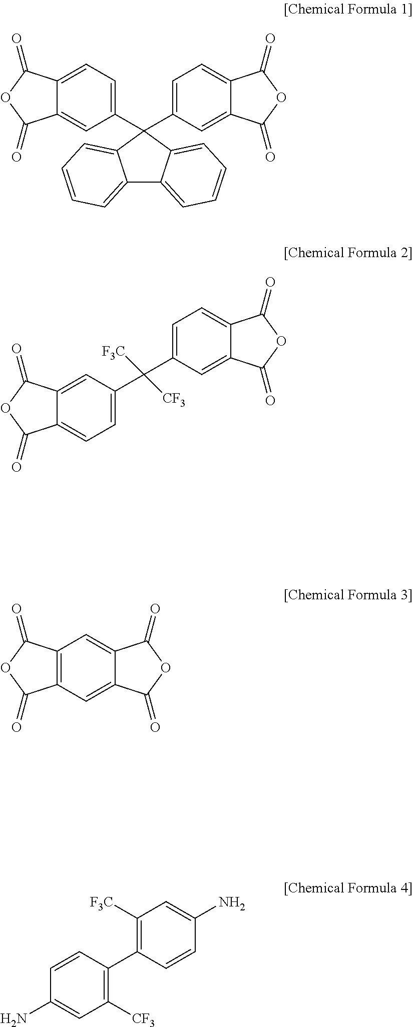 [SMILES: O=C1OC(=O)c2cc(C3(c4ccc5c(c4)C(=O)OC5=O)c4ccccc4-c4ccccc43)ccc21 ; O=C1OC(=O)c2cc(C(c3ccc4c(c3)C(=O)OC4=O)(C(F)(F)F)C(F)(F)F)ccc21 ; O=c1oc(=O)c2cc3c(=O)oc(=O)c3cc12 ; Nc1ccc(-c2ccc(N)cc2C(F)(F)F)c(C(F)(F)F)c1]
3,000≤V_{PI}≤10,000 [Relation 1]
wherein V_{PI} is as defined for Relation 1 in claim 1.

10. The method for preparing a composition for forming a polyimide film of claim 9, wherein
step ii) comprises:
further adding 5 to 50 parts by weight of the hydrocarbon-based solvent with respect to 100 parts by weight of the amide-based solvent of i) and performing stirring; and
further adding a mixed solvent of the amide-based solvent and the hydrocarbon-based solvent so that Relation 1 is satisfied.

11. A polyimide film obtained by curing the composition for forming a polyimide film of claim 1.

12. The polyimide film of claim 11, wherein the polyimide film has a coefficient of thermal expansion (CTE) of 15 ppm/° C. or less as measured in a temperature range of 100 to 450° C. by a thermomechanical analysis (TMA) method.

13. The polyimide film of claim 11, wherein the polyimide film has a thickness of 4 to 12 um and a yellow index (YI) in accordance with ASTM E313 of 15 or less.

14. A method for manufacturing a polyimide film, the method comprising:
an application process of applying the composition for forming a polyimide film of claim 1 on a substrate; and
a curing process of drying and heating the composition for forming a polyimide film to be cured.

15. The method for manufacturing a polyimide film of claim 14, wherein the curing process is performed by drying at 30° C. to 80° C. and then heating at 100° C. to 450° C.

16. The method for manufacturing a polyimide film of claim 14, further comprising:
after the application process, allowing the applied substrate to stand at room temperature.

17. A multilayer structure comprising the polyimide film of claim 11 and a semiconductor layer on one surface of a substrate.

18. The multilayer structure of claim 17, wherein the semiconductor layer comprises one or two or more selected from the group consisting of low-temperature polysilicon (LTPS), low-temperature polycrystalline oxide (LTPO), indium tin oxide (ITO), and indium gallium zinc oxide (IGZO).
